(19) United States
(12) Patent Application Publication
(10) Pub. No.: US 2005/0102923 A1
(43) Pub. Date: May 19, 2005

(54) Bracket and pole assembly

(76) Inventor: Robert E. Oidtman, Mt Pleasant, NC (US)

Correspondence Address: KATHLEEN M HARLESTON;THE HARLESTON LAW FIRM, 909 TALL PINE ROAD, MT PLEASANT, SC, 29464, US

(21) Appl. No.: 10/826,753

(22) Filed: Apr. 16, 2004

Related U.S. Application Data
(63) Continuation-in-part of application No. 10/713,245, filed on Nov. 14, 2003.

(51) Int. Cl. H02K 9/00

(52) U.S. Cl. 52/155; 52/169.9

(57) ABSTRACT

A bracket and pole assembly for outdoor use on a raised flooring surface includes: (a) at least one bracket including a bracket shaft and a bottom support, which is attachable to a floor joist of the raised flooring surface with the bracket shaft opening to a hole in the raised flooring surface; and (b) at least one pole assembly with a removable hollow pole, an end portion of the pole being removably insertable in the bracket shaft and supportable on the bottom support. The assembly preferably further includes a taut cable with a turnbuckle extending between the bottoms of two brackets.

### CROSS REFERENCE TO RELATED APPLICATION

This is a continuation-in-part of pending U.S. patent application Ser. No. 10/713,245, filed on Nov. 14, 2003.

### BACKGROUND OF THE INVENTION

1. Technical Field

The present invention relates to a bracket and pole support assembly for use on a raised flooring surface, such as an outdoor deck; more particularly, a bracket and pole assembly with a removable pole for supporting a hammock, tabletop, umbrella, bird feeder, or other outdoor living accessory.

2. Background Information

There is nothing better than laying outside in a hammock on a beautiful day. Unfortunately, hanging a hammock on a backyard deck is often a difficult task. Even if there is a tree or building structure conveniently available adjacent to the deck for supporting one end of the hammock, there is usually no other vertical support available on the deck for supporting the other end of the hammock. Most of the time, the only vertical supports on a deck are the wooden railings, which are usually not the right distance apart nor are they high enough to elevate a hammock off the deck surface. In addition to needing one or two sufficiently tall posts an appropriate distance apart for holding the ends of the hammock, the posts must have some attachment mechanism on which a hammock may be hung. On the other hand, if the homeowner does not leave the hammock up year round, a pole protruding from the center of a deck is undesirable, potentially hazardous, and can impinge on other uses of the deck. Simply nailing a bucket-shaped receptacle to a joist under a hole in a deck is inadequate for supporting a pole because of torque. In short, there is a need for an unobtrusive bracket and pole assembly for supporting a hammock and occasional or temporary use fixtures such as an umbrella or a party table.

Similarly, it may be desirable to hang a light, candle, flower pot, bird feeder, or other outdoor accessory on an outdoor deck, but a sufficiently high post or other support is often not available. Therefore, a need for an bracket and pole assembly for hanging lights, flower pots, bird feeders, and other outdoor devices exists.

Tables for decks cannot normally be disassembled and are difficult to store in a closet, shed, basement, or elsewhere because they are awkwardly shaped and occupy a large area. It is also sometimes desirable to have more available table surface than a typical deck table can provide, for example, during a barbecue, dinner party, reception, or other outdoor party. Therefore, a need for an bracket and pole assembly for supporting a removable tabletop, and optionally a lazy susan, exists. A need also exists for a heavy duty bracket and pole assembly for supporting a heavy weight on a hammock supported by the assembly.

### BRIEF SUMMARY OF THE INVENTION

The present invention is a bracket and pole assembly for supporting on a raised flooring surface a hammock, umbrella, tabletop with or without a lazy susan, lamp, bird feeder, hanging candle, flower pot, or other accessories for enhancing outdoor living. The bracket and pole assembly of the present invention includes: (a) at least one bracket comprising a bracket shaft and a bottom support; and (b) at least one pole assembly comprising a removable hollow pole, the pole being supportable on the bottom support. The bracket is attachable to a floor joist of the raised flooring surface, which is preferably an outdoor deck, so that the bracket shaft is directly below a hole in the flooring surface. The hollow pole is removably insertable through the hole in the flooring surface and into the bracket shaft, which supports the pole in an upright position.

In a preferred embodiment, the pole assembly further comprises a hook mechanism, a cap plug, a table attachment bolt shaft, and cushioning strips. A preferred bracket and pole assembly of the present invention also further comprises a filler plug for insertion into the bracket shaft and the hole in the flooring surface when the pole is absent. The bracket and pole assembly of the present invention preferably also includes a step down plug for accommodating poles with smaller outer diameters, as well as a table attachment mechanism for supporting a tabletop. The cap plug may comprise a lazy susan, light, flower pot or vase, bird feeder, or other accessory for enhancing outdoor living.

In a preferred, heavy duty embodiment, the bracket and pole assembly includes: (a) at least one heavy duty bracket comprising a heavy duty bracket shaft, a bottom support within the heavy duty bracket shaft, and a single bracket shaft joist wall attached to the heavy duty bracket shaft; the heavy duty bracket being attachable to a floor joist of the raised flooring surface with the heavy duty bracket shaft opening to a corresponding hole in the raised flooring surface; (b) at least one pole assembly comprising a removable hollow pole, an end portion of the pole being removably insertable in the heavy duty bracket shaft and supportable on the bottom support; and (c) a taut cable with one end attached to the heavy duty bracket.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 shows a front elevational view of a bracket of a bracket and pole assembly according to the present invention;

FIG. 2 is a top plan view of the bracket of the bracket and pole assembly according to FIG. 1;

FIG. 3 is a front elevational view of a first alternate embodiment of a bracket of a bracket and pole assembly according to the present invention;

FIG. 4 is a top plan view of the bracket according to FIG. 3;

FIG. 5 is a front elevational view of a second alternate embodiment of a bracket of a bracket and pole assembly according to the present invention;

FIG. 6 is a top plan view of the second alternate embodiment of a bracket of a bracket and pole assembly according to FIG. 5;

FIG. 7 is a side elevational view of a pole assembly of a bracket and pole assembly according to the present invention;

FIG. 8A is a side elevational view of an alternate embodiment of a pole assembly of a bracket and pole assembly according to the present invention;

FIG. 8B is a side elevational view of the hook from the bracket and pole assembly according to FIG. 8A;

FIG. 8C is a front elevational view of the hook from the bracket and pole assembly according to FIG. 8A;

FIG. 9 is a side elevational view of a bracket and pole assembly according to the present invention;

FIG. 10 is a side elevational view of an alternate embodiment of a bracket and pole assembly according to the present invention;

FIG. 10A is a side elevational view of two bracket and pole assemblies according to the present invention, shown supporting a hammock;

FIG. 11 is a side elevational view of a filler plug of a bracket and pole assembly according to the present invention;

FIG. 12 is a top plan view of the filler plug of the bracket and pole assembly according to FIG. 11;

FIG. 13 is a bottom plan view of the filler plug of the bracket and pole assembly according to FIG. 11;

FIG. 14 is a cutaway side elevational view of a filler plug in a bracket of a bracket and pole assembly according to the present invention;

FIG. 15 is a side elevational view of a step down plug of a bracket and pole assembly according to the present invention;

FIG. 16 is a top plan view of the step down plug of the bracket and pole assembly according to FIG. 15;

FIG. 17 is a bottom plan view of the step down plug of the bracket and pole assembly according to FIG. 15;

FIG. 18 is a cutaway side elevational view of a step down plug in a bracket of a bracket and pole assembly according to the present invention;

FIG. 19 is a side elevational view of an umbrella in a step down plug of a bracket and pole assembly according to the present invention;

FIG. 20 is a side elevational view of a table attachment of a bracket and pole assembly according to the present invention;

FIG. 21 is a top plan view of the table attachment according to FIG. 20;

FIG. 22 is a bottom plan view of the table attachment according to FIG. 20;

FIG. 23 is a side elevational view of a bracket and pole assembly according to the present invention, showing a tabletop, a table attachment mechanism, a lazy susan, and a lamp;

FIG. 24 is a side elevational view of a cap step down plug of a bracket and pole assembly according to the present invention;

FIG. 25 is a top plan view of the cap step down plug according to FIG. 24;

FIG. 26 is a bottom plan view of the cap step down plug according to FIG. 24;

FIG. 27 is a side elevational view of a bracket and pole assembly according to the present invention, showing a table attachment mechanism, a tabletop, a cap step down plug, and an outdoor accessory assembly with a flower pot;

FIG. 28 is a side elevational view of a bracket and pole assembly according to the present invention, showing a cap step down plug, a table attachment, a tabletop, and an umbrella;

FIG. 29 is a side elevational view of a bracket and pole assembly according to the present invention, showing a cap-step down plug, a cocktail tabletop, and an umbrella;

FIG. 30 is a side elevational view of a bracket and pole assembly according to the present invention, showing a bird feeder and a flower pot;

FIG. 31 is a front elevational view of a fourth alternate embodiment of a bracket of a bracket and pole assembly according to the present invention;

FIG. 32 is a top plan view of the bracket of the bracket and pole assembly according to FIG. 31;

FIG. 33 is a side elevational view of the bracket of the bracket and pole assembly according to FIG. 31;

FIG. 34 is a front elevational view of a fifth alternate embodiment of a bracket of a bracket and pole assembly according to the present invention;

FIG. 35 is a top plan view of the bracket of the bracket and pole assembly according to FIG. 34;

FIG. 36 is a side elevational view of the bracket of the bracket and pole assembly according to FIG. 34; and

FIG. 37 is a side elevational view of two bracket and pole assemblies according to the present invention, shown in use.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

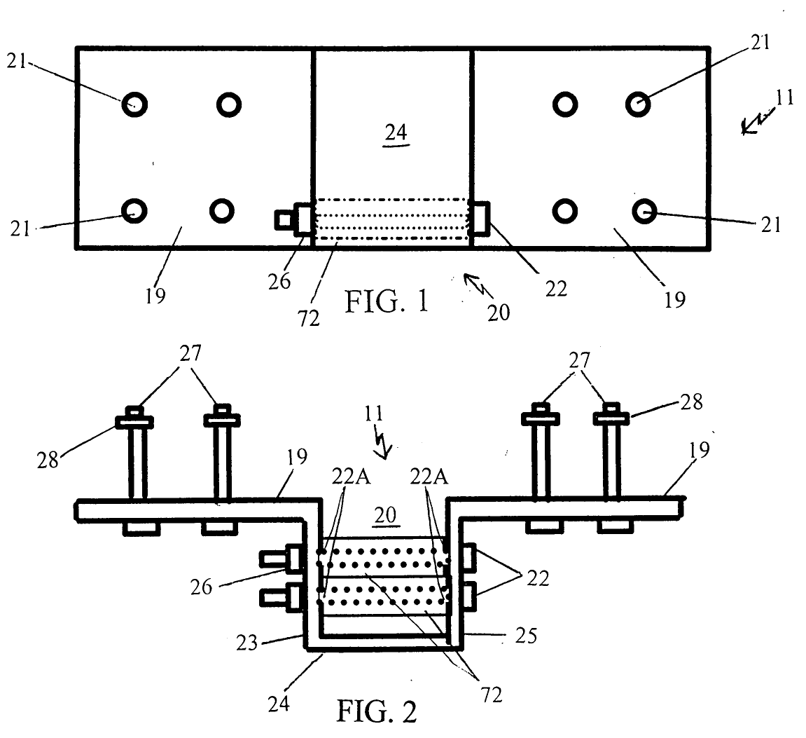

Turning first to FIGS. 1 and 2, a bracket and pole assembly according to the present invention, generally referred to as 10, is for use on a raised flooring surface, such as a deck. The bracket and pole assembly 10 comprises a bracket 11, which includes two bracket shaft joist walls 19 separated by a bracket shaft 20. In this first, preferred embodiment, the bracket shaft is enclosed by a first bracket wall 23, a second bracket wall 24, and a third bracket wall 25. A first end of the first bracket wall 23 is substantially perpendicularly connected to an end of one bracket shaft joist wall 19, and a first end of the third bracket wall 25 is substantially perpendicularly connected to an end of the other bracket shaft joist wall 19. The second bracket wall 24 is longitudinally oriented to the bracket shaft joist walls 19. Similarly, the first bracket support wall 23 and the third bracket wall 25 are both longitudinally oriented. In the preferred embodiment depicted in FIGS. 1 and 2, the bracket shaft joist walls 19, first bracket wall 23, second bracket wall 24, and third bracket wall 25 are each generally rectangular in shape. A plurality of similarly sized, spaced apart, generally circular bracket holes 21 extend transversely through the bracket shaft joist walls 19. To install the bracket 11 in the raised flooring surface, bracket bolts 22 are inserted perpendicularly through the bottom of the first bracket wall 23 and the bottom of the third bracket wall 25, so they extend through the bracket shaft.

Thus, the bracket shaft 20 has at least two bracket wall holes 22A, a first one of the holes 22A being in the first bracket wall 23 and a second one of the holes 22A being in the third bracket wall 25 (see FIG. 2). In this preferred embodiment, the bottom support is at least one bolt 22 extending perpendicularly through the first bracket wall hole 22A in the first bracket wall 23, and the second bracket wall hole 22A in the third bracket wall 25, and through the bracket shaft 20.

Bolt covers 72, which are generally cylindrical in shape and approximately equal in length to the width of the bracket shaft, preferably surround the bolts 22. Nuts 26 are secured to the ends of the bracket bolts 22 to hold the bolts in place. The bracket 11 and bracket bolts 22 are preferably made of a rustproof metal, such as stainless steel, galvanized steel, or aluminum. The bracket bolt covers 72 are preferably made of plastic and further protect the bracket bolts 22.

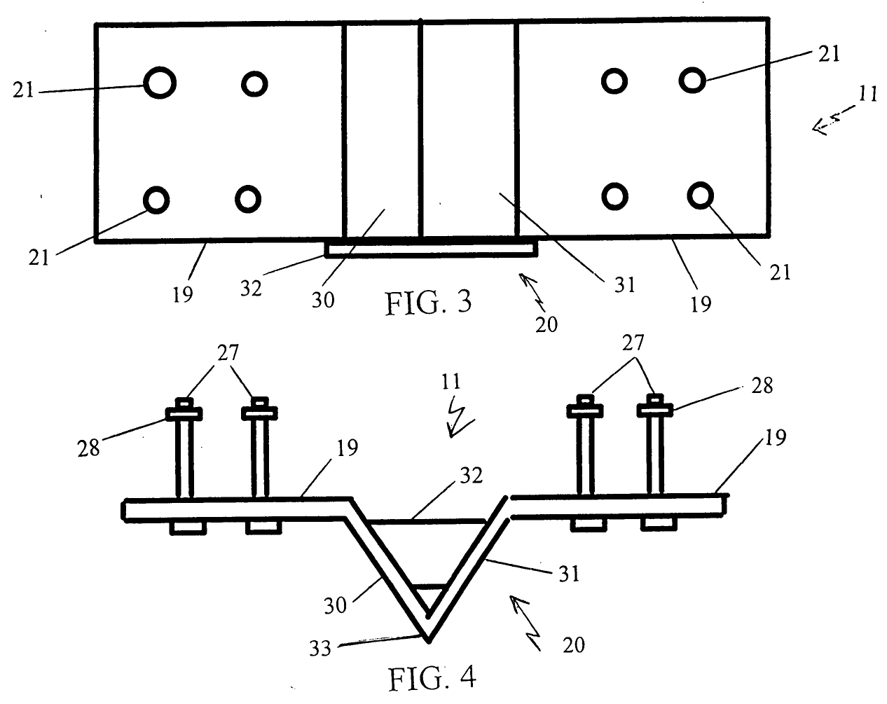

In an alternate embodiment depicted in FIGS. 3 and 4, the bracket 11 comprises two bracket shaft joist walls 19 separated by the bracket shaft 20, which has a first side 30, a second side 31, and a bottom support base plate 32. In this embodiment, the bracket shaft 20 is generally triangular in shape, a third side of the triangle (preferably equilateral) being provided by the floor joist. A first end of the first side 30 is connected at an obtuse angle to an end of one bracket shaft joist wall 19, and a first end of the second side 31 is connected at an obtuse angle to an end of another bracket shaft joist wall 19. A second end of the first side 30 is connected to a second end of the second side 31 to form an apex 33. The base plate 32, which is the bottom support, is welded to the bottom ends of the first side 30 and the second side 31 and spans between the first side 30 and the second side 31. The bracket shaft joist walls 19, first side 30, and second side 31 are preferably generally rectangular in shape. In order to permit water to drain from the bracket shaft 20, the base plate 32 preferably does not span the entire length of the first side 30 and the second side 31. A plurality of similarly sized, spaced apart, generally circular holes 21 extend transversely through the bracket shaft joist walls 19.

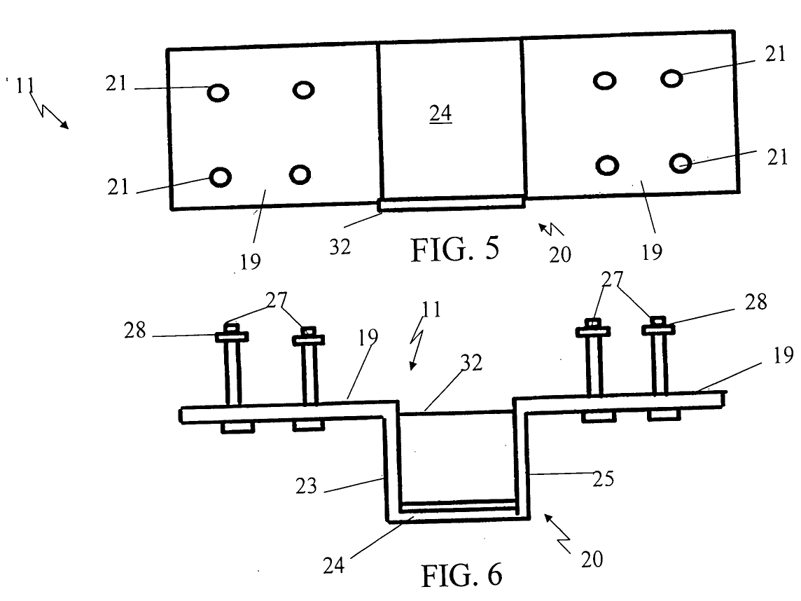

In a second alternate embodiment illustrated in FIGS. 5 and 6, the bracket 11 comprises two bracket shaft joist walls 19 separated by the bracket shaft 20. The bracket shaft 20 includes a first bracket wall 23, second bracket wall 24, third bracket wall 25, and a base plate 32. One end of the first bracket wall 23 and one end of a bracket shaft joist wall 19, as well as one end of the third bracket wall 25 and an end of the other bracket shaft joist wall 19, are substantially perpendicularly connected to one another. One end of the second bracket wall 24 and an end of the first bracket wall 23 are substantially perpendicularly connected, and an end of the second bracket wall 24 is substantially perpendicularly connected to an end of the third bracket wall 25, such that the second bracket wall 24 is longitudinally oriented to the bracket shaft joist walls 19. Similarly, the first bracket wall 23 and third bracket wall 25 are longitudinally oriented. The base plate 32, which is the bottom support the pole rests on, is welded to the bottom ends of the first bracket wall 23 and the third bracket wall 25 and spans between the first bracket wall 23 and the third bracket wall 25. The bracket shaft joist walls 19, first bracket wall 23, second bracket wall 24, third bracket wall 25, and the base plate 32 are preferably each generally rectangular in shape. In order to permit water to drain from the bracket shaft 20, the base plate 32 preferably does not span the entire length of the first bracket wall 23 and the third bracket wall 25. A plurality of similarly sized, spaced apart, generally circular holes 21 extend transversely through the bracket shaft joist walls 19.

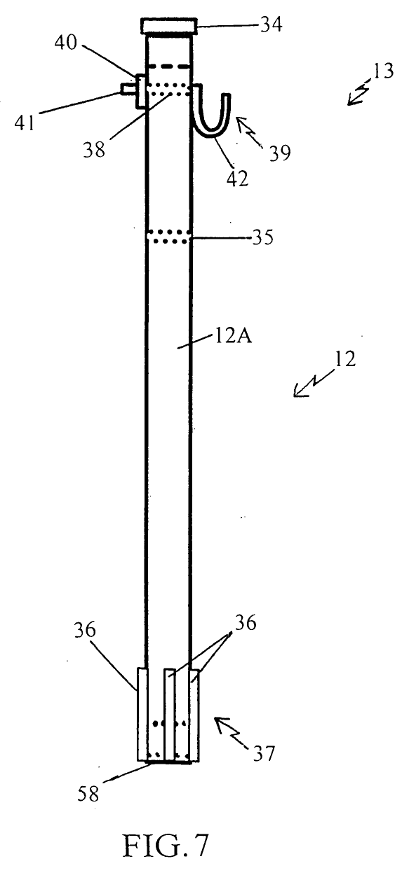

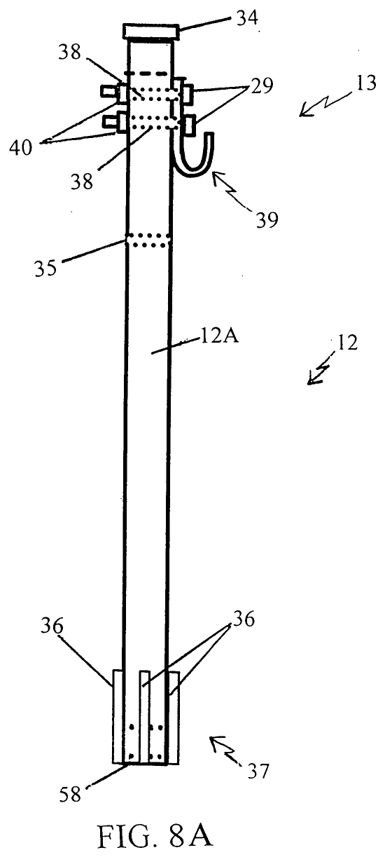

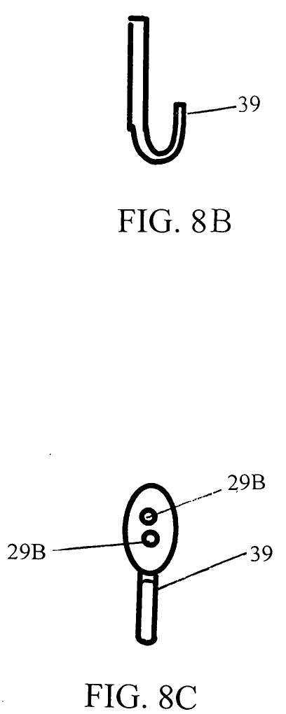

Referring to FIGS. 7 and 8A, the bracket and pole assembly 10 further comprises a pole assembly 12, which includes a pole 12A, a removable cap plug 34, a hook mechanism 13, a table attachment bolt shaft 35, cushion strips 36, and a base plug 58. The cushion strips 36 are mounted on the sides of the pole 12A at its base 37 and are longitudinally oriented with the pole 12A. The cushion strips 36 are preferably matching magnetic strips or waterproof dense foam strips. The pole 12A is preferably hollow, so that the cap plug 34 can be removably inserted into the top end of the pole 12A. The cap plug 34 prevents rainwater, insects such as spiders, and other undesirable elements from collecting inside the pole 12A. The hook mechanism 13 is located at the top end of the pole assembly 12 directly below the cap plug 34, while the table attachment bolt shaft 35 is bored transversely through the pole 12A below the hook mechanism 13. The base plug 58 is insertable in the bottom of the pole 12A and comprises a drain hole to allow any water that accumulates inside the pole 12A to drain out of the pole.

A first embodiment of the hook mechanism 13, which is shown in FIG. 7, comprises a hook bolt shaft 38, a hook 39, and a hook nut 40. The hook bolt shaft 38 is bored transversely through the pole 12A and a linear portion 41 of the hook 39 is inserted through the hook bolt shaft 38 until a curved hook portion 42 prevents further entry of the linear hook portion 41 into the hook bolt shaft 38. The hook nut 40 placed over the linear portion 41 abuts the pole 12A to secure the hook 39 within the pole 12A.

An alternate, preferred embodiment of a hook mechanism 13 shown in FIGS. 8A-C comprises hook bolt shafts 38, a hook 39, hook nuts 40, and hook bolts 29. The hook 39 is shown in greater detail in FIGS. 8B and 8C. The hook bolt shafts 38 are bored transversely through the pole 12A, one above another. Hook bolts 29 are inserted through holes 29A in the hook 39 and then through the hook bolt shafts 38 to connect the hook 39 to the pole 12A (see FIGS. 8A and 8C). Hook nuts 40 over the hook bolts 29 abut the pole 12A to secure the hook 39 on the pole 12A.

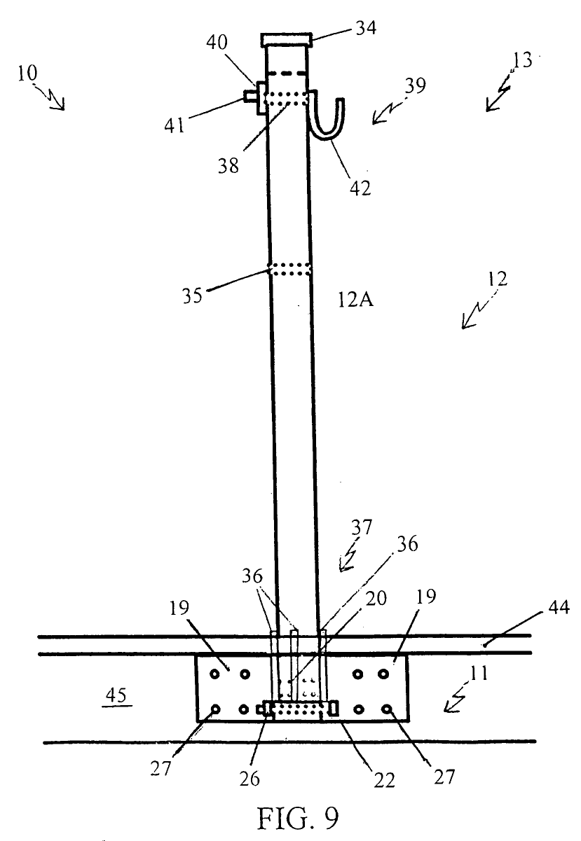

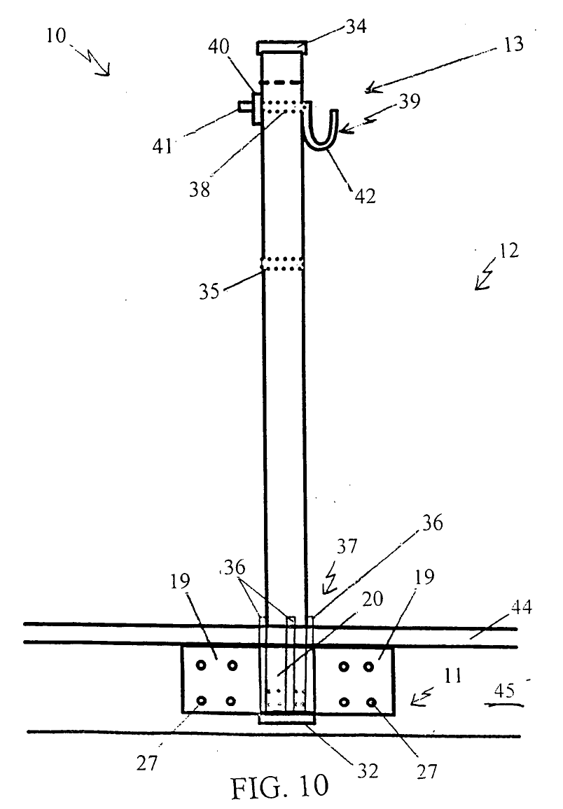

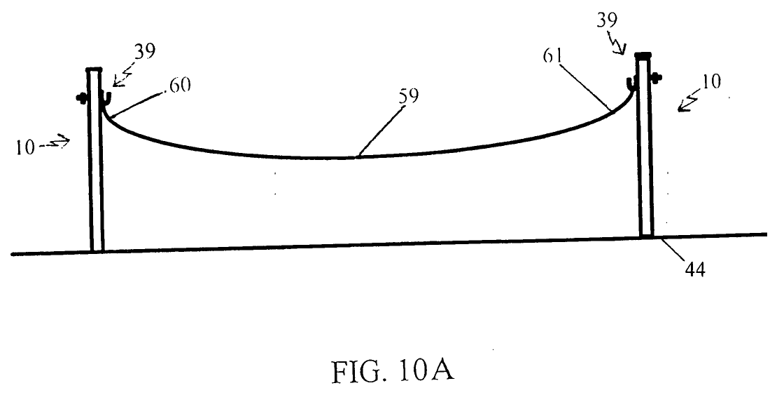

Turning now to FIGS. 9 and 10, a typical outdoor deck comprises a flooring surface 44 and floor joists 45. In order for the flooring surface 44 to accommodate the bracket and pole assembly 10, a generally circular hole with a diameter slightly greater than the outer diameter of the pole 12 is cut into the flooring surface 44 next to a floor joist 45. The bracket 11 is attached to the floor joist 45 with joist bolts 27 that extend through holes 21 and through the floor joist 45. Joist nuts 27 placed over the joist bolts 27 abut the floor joist 45 to further secure the bracket 11 to the floor joist 45. The bracket shaft 20 of the bracket 11 lies immediately below the hole in the flooring surface 44.

Next, the base plug 58 is inserted in the bottom of the pole assembly 12. Then the base 37 of the pole 12A is inserted through the hole in the flooring surface 44 and into the bracket shaft 20 until the pole base 37 contacts bolt covers 72 (shown in FIG. 9) or the base plate 32 (shown in FIG. 10). The bracket shaft 20 supports the pole 12A in a substantially vertical position. The cushion strips 36 and base plug 58 protect the finished surface of the pole 12A and the cushioning also insures that the pole 12A fits snugly within the bracket shaft 20. Other suitable types of cushioning may be used in place of cushion strips.

Referring to FIG. 10A, two bracket and pole assemblies 10 support a hammock 59 on a deck. A first bracket and pole assembly 10 is mounted on a floor joist 45 an appropriate distance from a second bracket and pole assembly 10 mounted on the same floor joist 45, or a different floor joist 45 depending upon the orientation of the hammock. A first end 60 of the hammock 59 is hung from the hook 39 on the first bracket and pole assembly 10 and a second end 61 of the hammock 59 is hung from the hook 39 on the second bracket and pole assembly 10.

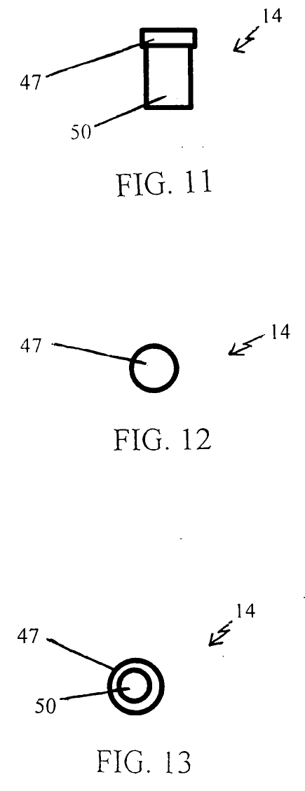

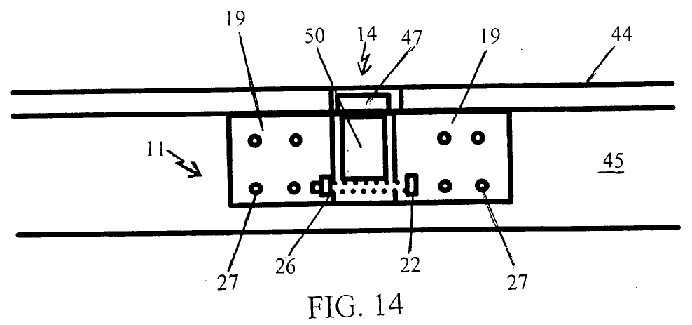

FIGS. 11 through 14 illustrate a filler plug 14 for removable insertion into the bracket shaft 20. FIG. 14 shows the hole in the flooring surface 44 when the pole 12A is absent from the bracket shaft 20. The filler plug 14 comprises a filler top section 47 attached to a filler bottom section 50. The filler bottom section 50 is preferably cylindrical in shape, and the diameter of the filler bottom section 50 is slightly less than the diameter of the hole in the flooring surface 44. The filler top section 47 is a generally circular cap attached to the filler bottom section 50. The filler plug 14 imparts an aesthetically pleasing finish to the flooring surface 44 when the pole 12A is absent from the bracket shaft 20. It also acts as a safety feature by preventing a person walking on the flooring surface 44 from tripping over or twisting their ankle in the hole in the flooring surface 44.

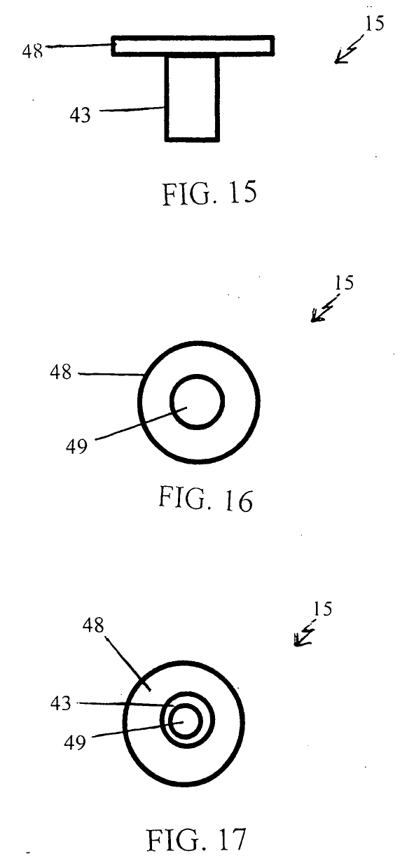

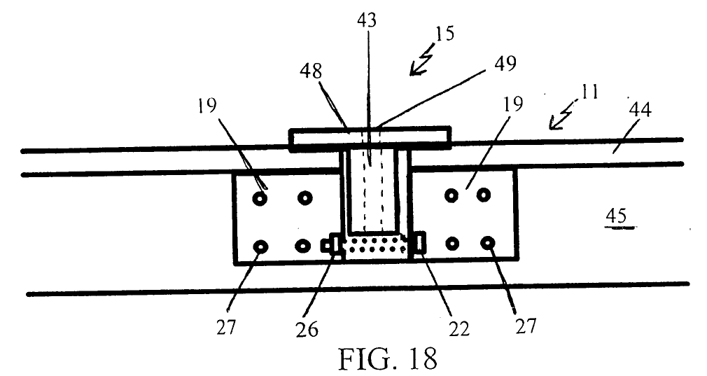

Turning next to FIGS. 15 through 18, a step down plug 15 is removably insertable through the hole in the flooring surface 44 and into the bracket shaft 20 so that the bracket and pole assembly 10 can accommodate a pole 12A. The pole 12A has an outer diameter smaller than the diameter of the hole in the flooring surface 44. The step down plug 15 comprises a step down plug bottom section 43 and a step down plug top section 48. The step down plug bottom section 43 and the step down plug top section 48 are preferably generally cylindrical in shape. The diameter of the step down plug bottom section 43 is smaller than the diameter of the step down plug top section 48, which is larger than the diameter of the hole in the flooring surface 44. Therefore, the step down plug top section 48 sits on the flooring surface 44. A generally circular step down plug aperture 49, in which a pole 12A having a diameter equal to the diameter of the step down plug aperture 49 is inserted, extends through the center of the step down plug bottom section 43 and the step down plug top section 48. The step down plug 15 is available with different diameters of the step down plug aperture 49 to hold poles 12A with different outer diameters.

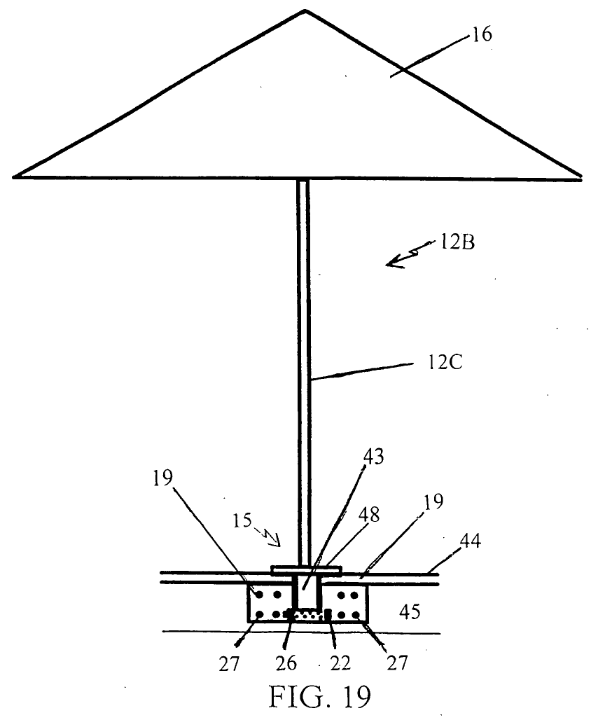

FIG. 19 illustrates an umbrella pole assembly 12B including an umbrella 16. A pole 12C of the umbrella pole assembly 12B is shown inserted into the step down plug 15.

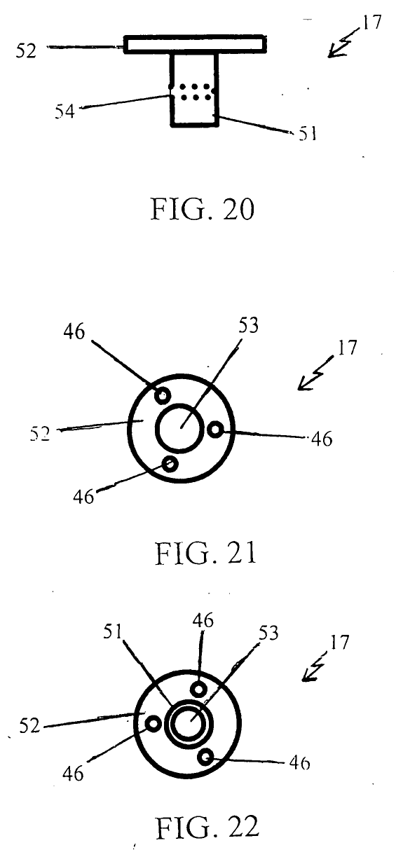

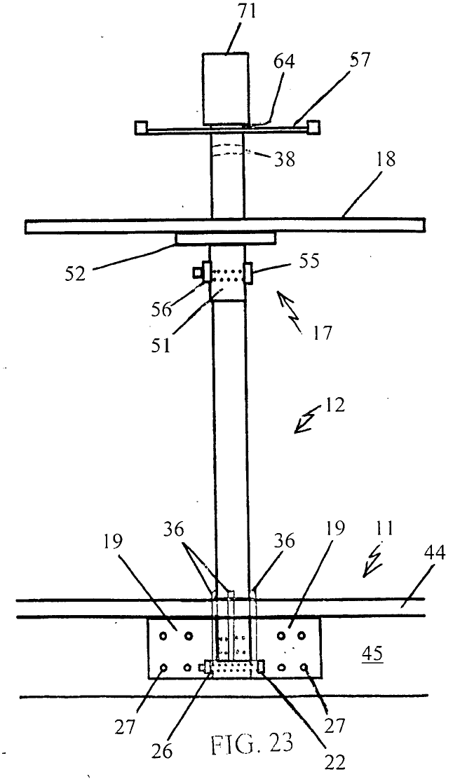

Referring to FIGS. 20 through 23, a tabletop attachment mechanism 17 comprises a table attachment top section 52, a table attachment bottom section 51, a table attachment aperture 53, a table bolt shaft 54, and table attachment holes 46. The table attachment top section 52 and the table attachment bottom section 51 are preferably generally cylindrical in shape. The diameter of the table attachment top section 52 is larger than the diameter of the table attachment bottom section 51, and a generally circular, table attachment aperture 53 runs through the center of the table attachment top section 52 and the table attachment bottom section 51. The diameter of the table attachment aperture 53 is preferably approximately equal to the outer diameter of the pole 12A. The table bolt shaft 54 is bored transversely through the table attachment bottom section 51. The table attachment holes 46 are bored through the table attachment top section 52 such that the table attachment holes 46 are substantially perpendicular to the table bolt shaft 54. The tabletop attachment mechanism 17 slides over the pole 12A and is removably attached to the pole 12A with a table bolt 55 inserted through the table bolt shaft 54 and the table attachment bolt shaft 35. As shown in FIG. 23, a table nut 56 placed over the table bolt 55 abuts the tabletop attachment mechanism 17 to further secure the tabletop attachment mechanism 17 to the pole 12A.

In use, a dinner-sized tabletop 18 is supported by the table attachment top section 52 of the tabletop attachment mechanism 17, as shown in FIG. 23. A central hole in the dinner tabletop 18 is placed over the top of the pole 12A. The tabletop hole has a diameter only slightly larger than the outer diameter of the pole 12A. The dinner tabletop 18 rests on the table attachment top section 52 and is secured to the table attachment top section 52 by bolts or screws that extend through the tabletop 18 and the table attachment holes 46. This dinner tabletop 18 comfortably supports a dinner for four people, for example.

The bracket and pole assembly 10 is preferably for outdoor use on a deck, although it can also be used indoors where the floor is raised above the foundation. For example, a reception room of a facility or a living room in a home might have several brackets 11 installed in the raised floor, optionally with a rug covering them. When a party is to be given, the rug is rolled up, and poles 12A are installed in the brackets 11 in an arrangement suitable for the type of party being given and the number of guests expected. Larger or smaller tabletops 18, 73 can be placed on the poles 12A. The tabletops can be used in combination with a table attachment mechanism, or they may be attached to a flat platform at the top of the pole.

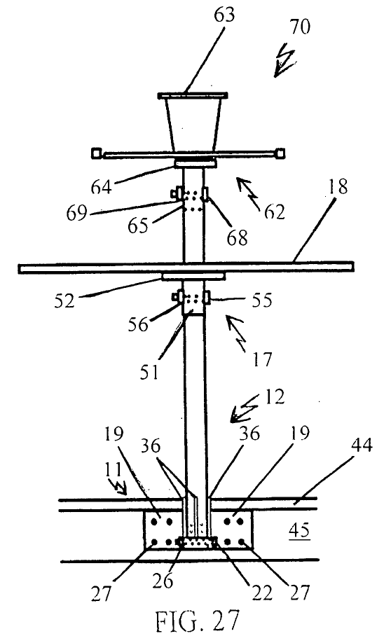

Also depicted in FIG. 23 is a cap step down plug 64 comprising a lazy susan 57 with a lamp 72 above it. In alternate embodiments, the cap plug 34 may comprise a vase or flower pot 63 (see FIG. 27), a bird feeder, a bird house, or other accessories for enhancing outdoor living.

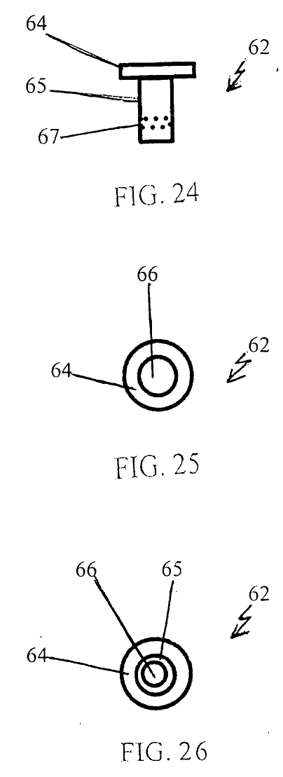

FIGS. 24 through 26 show a cap step down plug 62, which is insertable in the top of the pole assembly 12 in place of the cap plug 34. The cap step down plug 62 comprises a cap step down plug top section 64, a cap step down plug bottom section 65, a cap step down plug aperture 66, and an attachment bolt shaft 67, as shown in FIGS. 24 through 26. The cap step down plug top section 64 and the cap step down plug bottom section 65 are preferably generally cylindrical in shape. The diameter of the cap step down plug top section 64 is larger than the diameter of the cap step down plug bottom section 65, and a generally circular, cap step down plug aperture 66 extends through the center of the cap step down plug top section 64 and the cap step down plug bottom section 65. The attachment bolt shaft 67 extends transversely through the cap step down plug bottom section 65. The cap step down plug 62 slides into the top of the pole assembly 12 and is removably attached to the pole 12A with an attachment bolt 68 that is inserted through the hook bolt shaft 38 and the attachment bolt shaft 67. An attachment nut 69 placed over the attachment bolt 68 abuts the pole 12A to further secure the cap step down plug 62 within the pole 12A.

In use, an umbrella 16 or an outdoor accessory assembly 70 comprising, for example, a flower pot 63 (see FIG. 27), a lamp 71 (see FIG. 23), a lazy susan 57 (see FIG. 23), a hanging candle, or a bird feeder or bird house, is inserted into the cap step down plug aperture 66 of the cap step down plug 62. Alternatively, the cap plug 34 may be removed and a conventional umbrella pole can be inserted into the hollow pole 12A.

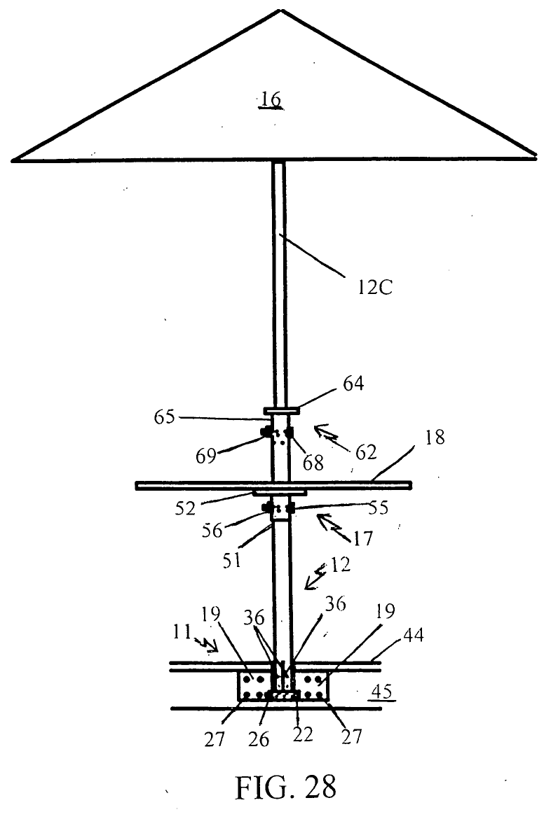

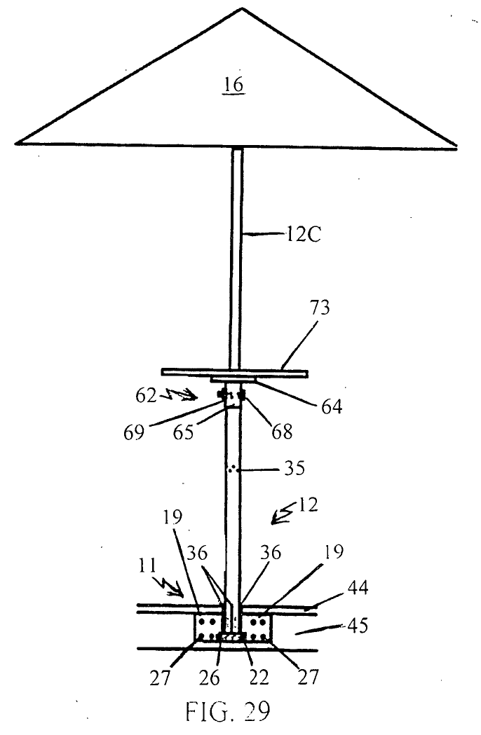

FIG. 29 shows a cap step down plug 62 supporting a cocktail tabletop 73. The cocktail tabletop 73 rests on the cap step down plug top section 64, with a generally circular aperture in the center of the cocktail tabletop being aligned with the cap step down plug aperture 66. Preferably the diameter of the aperture in the cocktail tabletop 73 is approximately equal to the diameter of the cap step down plug aperture 66. Any outdoor item, such as the umbrella 16, inserted into the cap step down plug aperture 66 holds the cocktail tabletop 73 in place on the cap step down plug top section 64. The cocktail tabletop 73 is smaller in diameter than the dinner tabletop 18 shown in FIG. 28, and is in a higher position on the pole. It is well suited for use with bar stools.

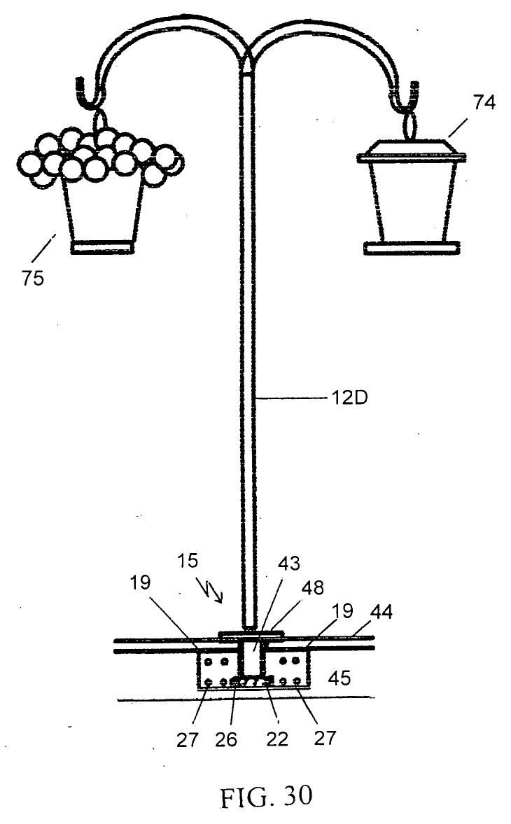

FIG. 30 shows a shepherds' hook pole 12D in a step down plug 15. A bird feeder 74 and a hanging flower container 75 are shown hanging from two crooks of the shepherd's hook pole 12D. Of course, other items can be hung from the crooks, such as hanging candles, a bird house, a banner, a wind sock, or wind chimes (not shown).

In the present invention, the bracket 11 supports the pole 12A, but does not secure it in place, so the pole 12A can be quickly and easily removed from the bracket 11. The hollow pole 12A has strategically placed shafts 35, 38 in it, as well as several attachments, e.g., hook 39, step down plug 15, table attachment mechanism 17, and cap step down plug 62, that fit into the shafts 35, 38. These make the pole 12A versatile, since the assembly 10 can easily be configured to accommodate a wide range of utilitarian and decorative accessories, e.g., umbrella 16, dining tabletop 18, lazy susan 57, hammock 59, cocktail tabletop 73, lamp 71, flower pot 63, hanging flower container 75, and bird feeder 74.

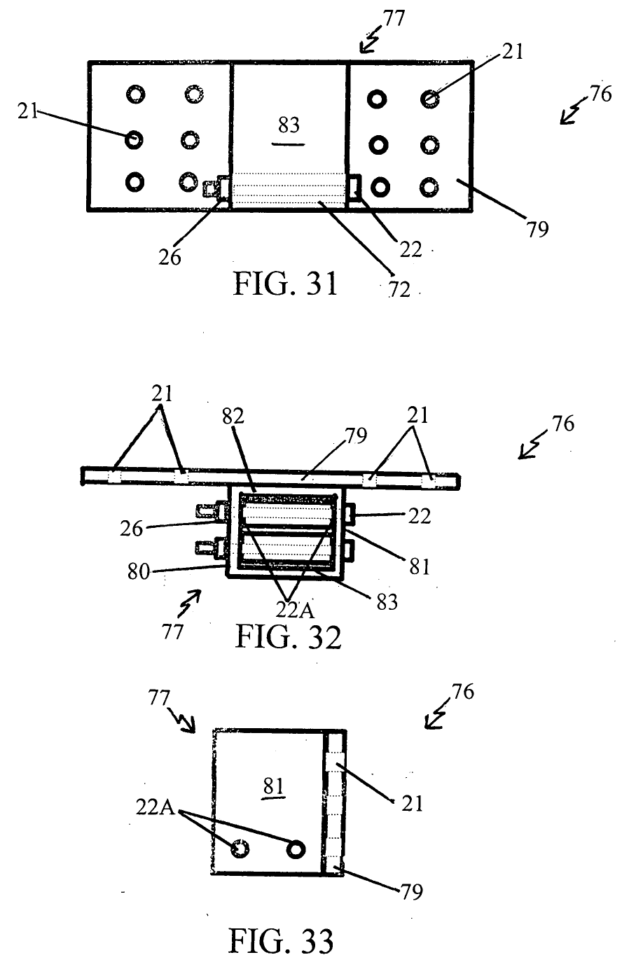

Turning to FIGS. 31-33, a fourth alternate embodiment of a first, heavy duty bracket 76 comprises a single bracket shaft joist wall 79 attached to a four-walled, heavy duty bracket shaft 77. The four-walled, heavy duty bracket shaft 77 is enclosed by a first pair of bracket walls 80, 81, which are oriented substantially parallel to one other, and a second pair of bracket walls 82, 83, which are oriented substantially parallel to one other and substantially perpendicular to the first pair of bracket walls 80, 81. Thus, the four-walled, heavy duty bracket shaft 77 is open-ended and generally rectangular in shape.

With regard to the four-walled, heavy duty bracket shaft 77, a first end of the first bracket wall 80 is substantially perpendicularly connected to a first end of the third bracket wall 82, and a second end of the first bracket wall 80 is substantially perpendicularly connected to a first end of the fourth bracket wall 83. A first end of the second bracket wall 81 is substantially perpendicularly connected to a second end of the third bracket wall 82, and a second end of the second bracket wall 81 is substantially perpendicularly connected to a second end of the fourth bracket wall 83. The third bracket wall 82 is mounted on a side of the single bracket shaft joist wall 79 at approximately the center of the single bracket shaft joist wall 79. The single bracket shaft joist wall 79 and bracket walls 80, 81, 82, 83 are each generally rectangular in shape. Preferably, the third bracket wall 82 is welded to the single bracket shaft joist wall 79, and the vertical dimensions of the single bracket shaft joist wall 79 are approximately equal to the vertical dimensions of the four-walled, heavy duty bracket shaft 77.

Continuing with FIGS. 31-33, a number of similarly sized, spaced apart, generally circular bracket holes 21 extend transversely through the bracket shaft joist wall 79 on both sides of the heavy duty bracket shaft 77. To install the first, heavy duty bracket 76 in the raised flooring surface, bracket bolts 22 are inserted perpendicularly through the bottom of the bracket walls 80, 81, so they extend through the heavy duty bracket shaft 77. Accordingly, the heavy duty bracket shaft 77 has at least two bracket wall holes 22A. A first one of the holes 22A is in the first bracket wall 80, and a second one of the holes 22A is in the second bracket wall 81 (see FIG. 32). In this preferred embodiment, the bottom support is at least one bolt 22 extending perpendicularly through the first bracket wall hole 22A in the first bracket wall 80, and the second bracket wall hole 22A in the opposite, second bracket wall 81, and through the heavy duty bracket shaft 77.

Bolt covers 72, which are generally cylindrical in shape and approximately equal in length to the width of the heavy duty bracket shaft, preferably surround the bolts 22. Nuts 26 are secured to the ends of the bracket bolts 22 to hold the bolts in place. The first, heavy duty bracket 76 and bracket bolts 22 are preferably made of a rustproof metal, such as stainless steel, galvanized steel, or aluminum. The bracket bolt covers 72 are preferably made of plastic and further protect the bracket bolts 22.

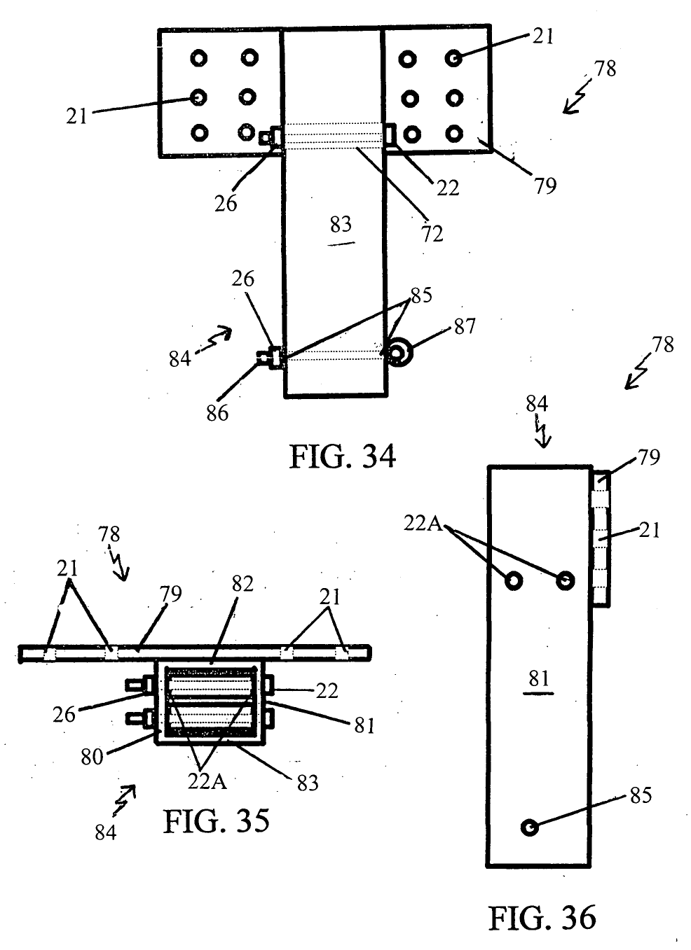

Referring to FIGS. 34-36, a fifth alternate embodiment of a second, heavy duty bracket 78 of a bracket and shaft assembly according to the present invention is substantially similar to the first, heavy duty bracket 76 depicted in FIGS. 31-33, except that the second, heavy duty bracket 78 comprises a single bracket shaft joist wall 79 and an attached, extended, four-walled bracket shaft 84. The lower portion of the extended, four-walled bracket shaft 84 extends past a bottom end of the single bracket shaft joist wall 79 (i.e., the vertical dimension of the bracket shaft 84 is greater than the vertical dimension of the single bracket shaft joist wall 79). Thus, the bracket holes 22A and the bracket bolt 22 pass through, and the bolt cover 72 extends between, the first pair of bracket walls 80, 81 in the vicinity of the bottom end of the single bracket shaft joist wall 79, but not at the bottom of the first pair of bracket walls 80, 81. Rather, in this embodiment, an I-bolt 86 passes through a corresponding I-bolt hole 85 in one of the bracket walls 80, 81 at the bottom of the bracket wall 80, 81. An eye 87 of the I-bolt 86 preferably abuts the bracket wall 81, and a nut 26 abutting the bracket wall 80 secures the I-bolt 86 within the extended, four-walled bracket shaft 84.

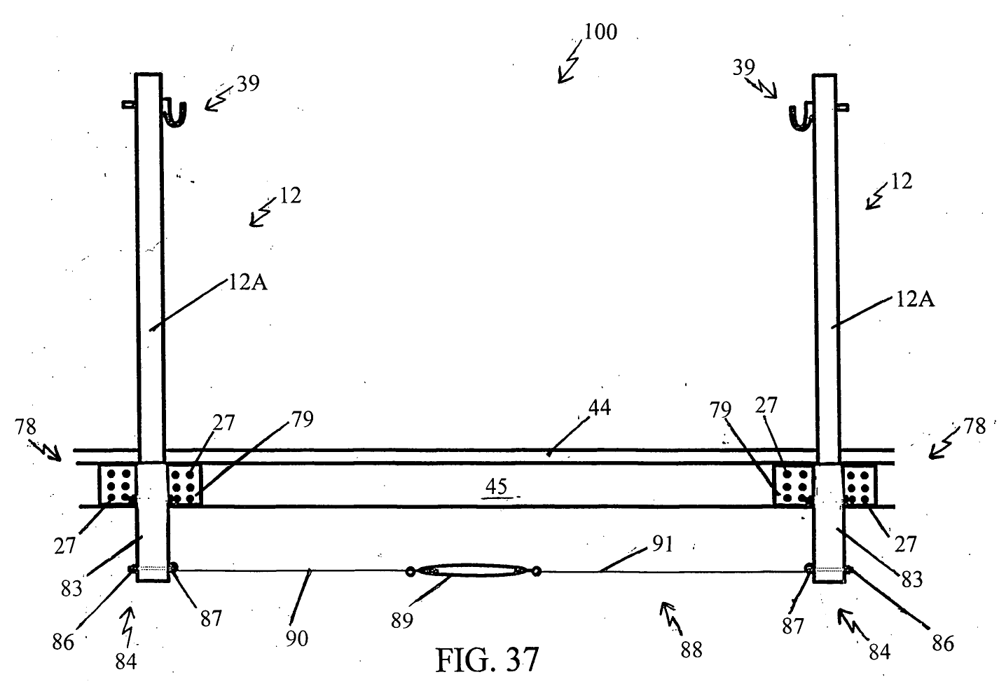

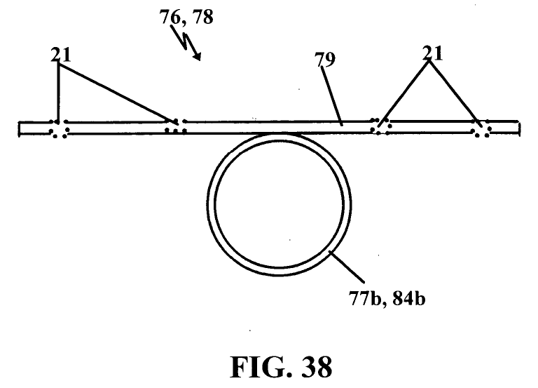

Lastly, as depicted in FIG. 37, a set of heavy duty brackets 78 with a taut cable 88 and turnbuckle 89 in a heavy duty bracket and pole assembly 100 are capable of supporting several hundred pounds of weight on a hammock (not shown) strung between the brackets 78. Two, identical, mirror image, spaced apart second, heavy duty brackets 78 may be installed as previously described on a floor joist 45 with joist bolts 27. The extended, four-walled bracket shafts 84 of the brackets 78 extend below the floor joist 45. Each extended, four-walled bracket shaft 84 accommodates and supports the pole 12A of the pole assembly 12, which is removably insertable in the extended, four-walled bracket shaft 84. If a clear deck is desired, for example, for a deck party, the hammock and poles 12A can easily be removed.

As illustrated in FIG. 37, the taut cable 88 extends between the eyes 87 of two I-bolts 86. The preferred turnbuckle 89 splits the cable 88 into two sections 90, 91, which are joined by the turnbuckle 89. The removable hammock (not shown) is hung between hooks 39 extending from poles 12A. Tightening the turnbuckle 89 during installation of the bracket and pole assembly pulls the cable 88 taut between the I-bolts 86, so that more weight can be supported on the hammock.

Instead of being hung between two brackets 76, 78, the hammock may alternatively be hung between one bracket 76, 78 on the deck or other raised flooring surface and another stable structure, such as a side of a house adjacent to the deck, or a nearby mature tree. In this case, the cable 88 would be attached to the I-bolt 86 of the bracket, and to an eye of a screw or the like embedded in the alternate structure.

Although a pole 12A made of a strong material may not bend under the weight of the occupant(s) of the hammock, a strong pole 12A does not affect the force applied to the bracket and pole assemblies 100. Too much weight in the hammock could theoretically fracture or break a wooden floor joist 45, or even cause a bracket to detach from a floor joist 45. The cable 88, optionally with its turnbuckle 89, is advantageous in that it distributes the hammock's weight along the cable 88, and lessens stress and strain on the second, heavy duty bracket 78 and the floor joist 45. The turnbuckle 89 allows the cable 88 to be tightened upon installation.

Also included herein is a kit comprising at least one bracket and pole assembly 10, 100 for use on a raised flooring surface. The kit comprises:
(a) at least one bracket 11, 76, 78 comprising a bracket shaft 20, 77, 84; the bracket 11, 76, 78 being attachable to a floor joist 45 with the bracket shaft 20, 77, 84 opening to a hole in the raised flooring surface 44; and
(b) at least one pole assembly 12 comprising a removable hollow pole 12A, an end portion of the pole 12A being removably insertable in the bracket shaft 20;
(c) at least one tabletop 18, 73 having a central hole with a slightly larger diameter than the diameter of the pole 12A;
(d) at least one tabletop attachment mechanism 17. The kit preferably further comprises:
(e) at least one cap step down plug 62 insertable in the top of the pole assembly 12, the cap step down plug 62 comprising a cap step down plug aperture 66; and
(f) at least one outdoor accessory assembly 70 removably insertable in the cap step down plug aperture 66. The kit preferably further comprises: (g) a cable 88 with an in-line turnbuckle 89, the cable being extendible between two of the brackets 76, 78. These items are illustrated in the figures herein.

From the foregoing it can be realized that the described device of the present invention may be easily and conveniently utilized as a versatile outdoor bracket and pole assembly. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 bracket and pole assembly
11 bracket of first embodiment
12 pole assembly
12A pole
12B pole, alternate embodiment
12C pole, alternate embodiment
12D shepherd's hook pole
13 hook mechanism
14 filler plug
15 step down plug
16 umbrella
17 tabletop attachment mechanism
18 dinner-type tabletop
19 bracket shaft joist wall
20 bracket shaft
21 bracket holes
22 bracket bolts
22A bracket wall hole
23 first bracket wall
24 second bracket wall
25 third bracket wall
26 nuts
27 joist bolts
28 joist nuts
29 hook bolts
30 first side
31 second side
32 base plate
33 apex
34 cap plug
35 table attachment bolt shaft
36 cushion strips
37 pole base
38 hook bolt shaft
39 hook
40 hook nut
41 linear hook portion
42 curved hook portion
43 step down plug bottom section
44 flooring surface
45 floor joist
46 table attachment hole
47 filler top section
48 step down plug top section
49 step down plug aperture
50 filler bottom section
51 table attachment bottom section
52 table attachment top section
53 table attachment aperture
54 table bolt shaft
55 table bolt
56 table nut
57 lazy susan
58 base plug
59 hammock
60 first end
61 second end
62 cap step down plug
63 flower pot
64 cap step down plug top section
65 cap step down plug bottom section
66 cap step down plug aperture
67 attachment bolt shaft
68 attachment bolt
69 attachment nut
70 outdoor accessory assembly
71 lamp
72 bolt cover
73 cocktail tabletop
74 bird feeder
75 hanging flower container
76 first, heavy duty bracket
77 four-walled bracket shaft
78 second, heavy duty bracket
79 single bracket shaft joist wall
80 first bracket wall, last embodiments
81 second bracket wall, last embodiments
82 third bracket wall, last embodiments
83 fourth bracket wall, last embodiments
84 extended, four-walled bracket shaft
85 I-bolt hole
86 I-bolt
87 eye
88 cable
89 turnbuckle

1. A bracket and pole assembly for use on a raised flooring surface, the assembly comprising:
(a) at least one bracket comprising a bracket shaft and a bottom support; the at least one bracket being attachable to a floor joist of the raised flooring surface with the bracket shaft being openable to a hole in the raised flooring surface; and
(b) at least one pole assembly comprising a removable hollow pole, an end portion of the pole being removably insertable in the bracket shaft and supportable on the bottom support.

2. The bracket and pole assembly according to claim 1, wherein the bracket shaft is enclosed by three bracket shaft walls, an end of a first one of the bracket shaft walls being attached to a second one of the bracket shaft walls, an end of the second bracket shaft wall being attached to an end of a third one of the bracket shaft walls, a joist of the raised flooring surface comprising a fourth bracket shaft wall.

3. The bracket and pole assembly according to claim 2, wherein the at least one bracket further comprises two bracket shaft joist walls separated by the bracket shaft, a first one of the bracket shaft joist walls being substantially perpendicularly connected at an end to the first bracket wall, a second one of the bracket shaft joist walls being substantially perpendicularly connected at an end to a first end of the third bracket wall, the third bracket wall being substantially perpendicularly connected at a second end to the second bracket shaft joist wall, the bracket shaft joist walls being connectable to the floor joist.

4. The bracket and pole assembly according to claim 1, wherein the at least one pole assembly further comprises:
(a) cushioning along a base portion of the pole;
(b) a cap plug removably insertable in a top end of the pole; and
(c) a hook mechanism below the cap plug and above the pole base portion.

5. The bracket and pole assembly according to claim 4, wherein the pole assembly further comprises:
(d) a base plug removably insertable in a bottom end of the pole; and
(e) a table attachment bolt shaft extending transversely through the pole below the hook mechanism.

6. The bracket and pole assembly according to claim 4, wherein the hook mechanism comprises a hook having a linear portion and a curved portion, and a hook bolt shaft extending transversely through the pole, the linear portion of the hook extending through the hook bolt shaft.

7. The bracket and pole assembly according to claim 3, further comprising at least two bracket wall holes, a first one of the bracket wall holes being in the first bracket wall and a second one of the bracket wall holes being in the third bracket wall; and wherein the bottom support is at least one bolt extending perpendicularly through the first bracket wall hole in the first bracket wall and the second bracket wall hole in the third bracket wall, and through the bracket shaft.

8. The bracket and pole assembly according to claim 7, wherein the first and second bracket shaft joist walls, and the first, second, and third bracket walls are each generally rectangular in shape.

9. The bracket and pole assembly according to claim 2, wherein the bracket shaft comprises a first side and a second side; a first end of the first side being connected at an obtuse angle to the first bracket shaft joist wall; a second, opposite end of the first side being connected to a first end of the second side to form an apex; a second, opposite end of the second side being connected at an obtuse angle to the second bracket shaft joist wall.

10. The bracket and pole assembly according to claim 9, wherein the bottom support is a base plate, the base plate being affixed to a bottom end of the first side and a bottom end of the second side; and wherein the first bracket shaft joist wall, the second bracket shaft joist wall, the first side, and the second side are each generally rectangular in shape.

11. The bracket and pole assembly according to claim 1, wherein the bracket shaft comprises a first bracket wall, a second bracket wall, and a third bracket wall; a first end of the first bracket wall being substantially perpendicularly connected to a first bracket shaft joist wall; a second, opposite end of the first bracket wall being substantially perpendicularly connected to a first end of the second bracket wall; a second, opposite end of the second bracket wall being substantially perpendicularly connected to a second end of the third bracket wall; a first end of the third bracket wall being substantially perpendicularly connected to a second bracket shaft joist wall, the bracket shaft joist walls being connectable to the floor joist.

12. The bracket and pole assembly according to claim 11, wherein the bottom support is a base plate, the base plate being affixed to a bottom end of the first bracket wall and a bottom end of the third bracket wall.

13. The bracket and pole assembly according to claim 12, wherein the hook mechanism comprises a hook, and a plurality of hook bolt shafts and hook bolts; the hook bolt shafts extending transversely through the pole; the hook bolts being insertable through the hook and the hook bolt shafts.

14. The bracket and pole assembly according to claim 3 further comprising a filler plug, which comprises:
(a) a filler bottom section that is generally cylindrical in shape, a diameter of the filler bottom section being less than the diameter of the hole in the flooring surface; and
(b) a generally circular filler top section connected to the filler bottom section;
wherein the filler plug is removably insertable in the bracket shaft.

15. The bracket and pole assembly according to claim 3 further comprising a step down plug, which comprises:
(a) a step down plug top section;
(b) a step down plug bottom section connected to the step down plug top section, the step down plug bottom section being removably insertable in the bracket shaft; and
(c) a generally circular step down plug aperture extending through a center of the step down plug top section and the step down plug bottom section.

16. The bracket and pole assembly according to claim 3, further comprising a table attachment mechanism, the table attachment mechanism comprising:
(a) a table attachment top section;
(b) a table attachment bottom section connected to the table attachment top section;
(c) a generally circular table attachment aperture extending through the center of the table attachment top section and the center of the table attachment bottom section; and
(d) a table bolt shaft extending transversely through the table attachment bottom section.

17. The bracket and pole assembly according to claim 16, wherein the table attachment top section and the table attachment bottom section are generally cylindrical in shape, a diameter of the table attachment aperture is about equal to an outer diameter of the pole, and a diameter of the table attachment bottom section is smaller than a diameter of the table attachment top section.

18. The bracket and pole assembly according to claim 16, wherein the table attachment aperture is slidable over the pole and the table attachment is removably secured to the pole by a table bolt inserted through the table bolt shaft and the table attachment bolt shaft.

19. The bracket and pole assembly according to claim 7, further comprising a cylindrical bolt cover over each bracket wall bolt, the bolt cover being about equal in length to the width of the bracket shaft.

20. The bracket and pole assembly according to claim 4, wherein the cap plug comprises a lamp.

21. The bracket and pole assembly according to claim 19, wherein a central hole in a tabletop has a diameter about equal to an outer diameter of the pole, the hole in the tabletop is slidable over the pole, and the table attachment mechanism supports the tabletop.

22. The bracket and pole assembly according to claim 3 further comprising a cap step down plug, the cap step down plug comprising:
(a) a cap step down plug top section;
(b) a cap step down plug bottom section connected to the cap step down plug top section;
(c) a generally circular cap step down plug aperture extending through the center of the cap step down plug top section and the center of the cap step down plug bottom section; and
(d) an attachment bolt shaft extending transversely through the cap step down plug bottom section;
wherein the cap step down plug bottom section is insertable in a top end of the pole.

23. The bracket and pole assembly according to claim 24, wherein an outdoor accessory assembly is removably insertable in the cap step down plug aperture of the cap step down plug, the cap step down plug being removably secured to the pole by an attachment bolt through the attachment bolt shaft and the hook bolt shaft.

24. The bracket and pole assembly according to claim 25, wherein an umbrella is removably insertable in the cap step down plug aperture of the cap step down plug.

25. The bracket and pole assembly according to claim 22, wherein the outdoor accessory assembly comprises a lazy susan.

26. A kit comprising at least one bracket and pole assembly for use on a raised flooring surface, the kit comprising:
(a) at least one bracket comprising a bracket shaft; the at least one bracket being attachable to a floor joist with the bracket shaft openable to a hole in the raised flooring surface;
(b) at least one pole assembly comprising a removable hollow pole, an end portion of the pole being removably insertable in the bracket shaft;
(c) at least one tabletop attachable to the at least one pole assembly; and
(d) at least one tabletop attachment mechanism.

27. The kit according to claim 26, further comprising:
(e) at least one cap step down plug insertable in the top of the at least one pole assembly, the at least one cap step down plug comprising a cap step down plug aperture; and
(f) at least one outdoor accessory assembly removably insertable in the cap step down plug aperture.

28. The kit according to claim 26, further comprising:
(g) a cable with an in-line turnbuckle, the cable being extendible between two of the at least one brackets.

29. A heavy duty bracket and pole assembly for use on a raised flooring surface, the assembly comprising:
(a) at least one heavy duty bracket comprising a heavy duty bracket shaft, a bottom support within the heavy duty bracket shaft, and a single bracket shaft joist wall attached to the heavy duty bracket shaft; the at least one heavy duty bracket being attachable to a floor joist of the raised flooring surface with the heavy duty bracket shaft opening to a corresponding hole in the raised flooring surface;
(b) at least one pole assembly comprising a removable hollow pole, an end portion of the pole being removably insertable in the heavy duty bracket shaft and supportable on the bottom support; and
(c) a taut cable with one end attached to the at least one heavy duty bracket.

30. The heavy duty bracket and pole assembly according to claim 29, further comprising a turnbuckle in the cable; and wherein the assembly comprises two spaced-apart ones of the at least one bracket, with each opposite cable end being attached to one of the two brackets.

31. The heavy duty bracket and pole assembly according to claim 30, wherein the heavy duty bracket shaft is a four-walled bracket shaft enclosed by a first pair of bracket walls that are oriented substantially parallel to one other, and a second pair of bracket walls that are oriented substantially parallel to one other, and substantially perpendicular to the first pair of bracket walls.

32. The heavy duty bracket and pole assembly according to claim 31, wherein the bottom support is at least one bolt extending perpendicularly through a first bracket wall hole in a first one of the first pair of bracket walls, and a second bracket wall hole in a second, opposite, one of the bracket walls, and through the heavy duty bracket shaft.

33. The heavy duty bracket and pole assembly according to claim 29, wherein the heavy duty bracket shaft is an attached, extended, four-walled bracket shaft, a vertical dimension of the extended, four-walled bracket shaft being greater than a vertical dimension of the single bracket shaft joist wall.

34. The heavy duty bracket and pole assembly according to claim 33, further comprising at least one I-bolt having an eye, the I-bolt extending through a corresponding I-bolt hole in a bracket wall of the four-walled, heavy duty bracket shaft.

35. The heavy duty bracket and pole assembly according to claim 30, wherein the heavy duty bracket shaft is cylindrical in shape.

36. The heavy duty bracket and pole assembly according to claim 29, wherein the heavy duty bracket shaft is an attached, extended, cylindrical bracket shaft, a vertical dimension of the extended, cylindrical bracket shaft being greater than a vertical dimension of the single bracket shaft joist wall.
